(19) United States
(12) Patent Application Publication
(10) Pub. No.: US 2013/0158165 A1
(43) Pub. Date: Jun. 20, 2013

(54) EPOXY RESIN COMPOSITION FOR ENCAPSULATING SEMICONDUCTOR DEVICE AND SEMICONDUCTOR DEVICE ENCAPSULATED WITH THE SAME

(71) Applicants: Seung HAN, Uiwang-si, Gyeonggi-do (KR); Ju Mi KIM, Uiwang-si, Gyeonggi-do (KR); Sung Su PARK, Uiwang-si, Gyeonggi-do (KR); Eun Jung LEE, Uiwang-si, Gyeonggi-do (KR)

(72) Inventors: Seung HAN, Uiwang-si, Gyeonggi-do (KR); Ju Mi KIM, Uiwang-si, Gyeonggi-do (KR); Sung Su PARK, Uiwang-si, Gyeonggi-do (KR); Eun Jung LEE, Uiwang-si, Gyeonggi-do (KR)

(21) Appl. No.: 13/719,875

(22) Filed: Dec. 19, 2012

(30) Foreign Application Priority Data
Dec. 20, 2011 (KR) 10-2011-0138667

(51) Int. Cl. C09D 163/00

(52) U.S. Cl. CPC C09D 163/00
USPC 523/452; 523/400; 523/455; 523/457

(57) ABSTRACT

An epoxy resin composition for encapsulating a semiconductor device and a semiconductor device encapsulated with the composition, the composition including an epoxy resin; an inorganic filler; a curing accelerator; and a curing agent, the curing agent including a compound having a multifunctional novolac structure including at least one biphenyl moiety, the compound being represented by Formula 1:

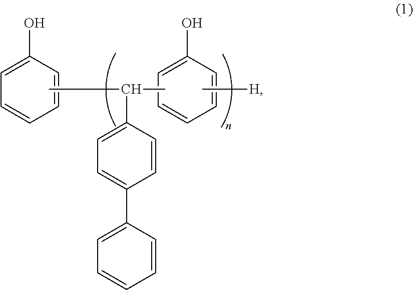

wherein n is about 1 to about 10.

### CROSS-REFERENCE TO RELATED APPLICATION

The present application claims priority under 35 U.S.C. §119 to Korean Patent Application No. 10-2011-0138667, filed on Dec. 20, 2011, in the Korean Intellectual Property Office, and entitled: “Epoxy Resin Composition for Encapsulating Semiconductor Device and Semiconductor Device Encapsulated with the Same,” which is incorporated by reference herein in its entirety.

### BACKGROUND

1. Field

Embodiments relate to an epoxy resin composition for encapsulating a semiconductor device and a semiconductor device encapsulated with the same.

2. Description of the Related Art

Epoxy resin compositions for encapsulating semiconductor devices should have good flame retardancy. UV94 V-0 is a criterion for the flame retardancy of epoxy resin compositions required by most semiconductor companies. Such a high level of flame retardancy may be ensured by the use of halogenated flame retardants, e.g., brominated epoxy resins, and inorganic flame retardants, e.g., antimony trioxide, in the preparation of epoxy resin compositions for encapsulating semiconductor devices.

However, epoxy resin compositions for encapsulating semiconductor devices using halogenated flame retardants (to ensure good flame retardancy) may produce toxic carcinogenic substances, e.g., dioxin or difuran, upon incineration or fire and/or release toxic gases, e.g., hydrogen bromide (HBr) and hydrogen chloride (HCl), upon combustion. Such toxic substances and gases are harmful to humans and may be corrosive to semiconductor chips, wires, and/or lead frames.

Organic non-halogenated flame retardants and inorganic flame retardants may be used. Phosphorus-based flame retardants, e.g., phosphazene and phosphoric acid esters, and other flame retardants, such as nitrogen-containing resins, may be used as the organic flame retardants. However, the nitrogen-containing resins may be used in excessive amounts due to their poor flame retardancy. The organic phosphorus-based flame retardants may have low reliability, similar to inorganic phosphorus-based flame retardants.

Inorganic non-halogenated flame retardants, e.g., magnesium hydroxide and zinc borate, may be used. However, the inorganic flame retardants may be used in large amounts to ensure good flame retardancy. In this case, the inorganic flame retardants may deteriorate curability and continuous moldability of epoxy resin compositions for encapsulating semiconductor devices. In order to minimize such deterioration, a reduction in the amount of the inorganic flame retardants used may be desirable. To this end, epoxy resins and curing agents of the epoxy resin compositions for encapsulating semiconductor devices may have a predetermined level of flame retardancy.

### SUMMARY

Embodiments are directed to an epoxy resin composition for encapsulating a semiconductor device and a semiconductor device encapsulated with the same

The embodiments may be realized by providing an epoxy resin composition for encapsulating a semiconductor device, the composition including an epoxy resin; an inorganic filler; a curing accelerator; and a curing agent, the curing agent including a compound having a multifunctional novolac structure including at least one biphenyl moiety, the compound being represented by Formula 1:

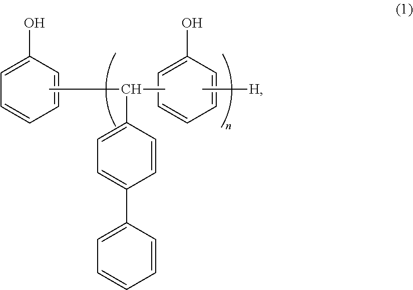

wherein n is about 1 to about 10.

The epoxy resin composition may further include a non-halogenated flame retardant.

The epoxy resin composition may include about 1 to about 13% by weight of the epoxy resin, about 74 to about 94% by weight of the inorganic filler, about 0.001 to about 1.5% by weight of the curing accelerator, about 0.001 to about 10% by weight of the non-halogenated flame retardant, and about 1 to about 15% by weight of the curing agent.

The non-halogenated flame retardant may include at least one of phosphazene, zinc borate, aluminum hydroxide, and magnesium hydroxide.

The curing agent may have a hydroxyl equivalent weight of about 100 g/eq to about 350 g/eq.

The curing agent may have a melt viscosity of about 0.08 poise to about 3 poise at 150° C.

The curing agent may have a softening point of about 50 to about 140° C.

The compound represented by Formula 1 may be present in the composition an amount of about 1 to about 15% by weight, based on a total weight of the epoxy resin composition.

The curing agent may further include at least one additional compound, the additional compound including two or more phenolic hydroxyl groups.

The compound represented by Formula 1 may be present in the composition in an amount of about 30% by weight or greater, based on a total weight of the curing agent.

The additional compound may include at least one of a phenol aralkyl type phenolic resin, a phenol novolac type phenolic resin, a xyloc type phenolic resin, a cresol novolac type phenolic resin, a naphthol type phenolic resin, a terpene type phenolic resin, a multifunctional type phenolic resin, a multiaromatic phenolic resin, a dicyclopentadiene type phenolic resin, a terpene-modified phenolic resin, a dicyclopentadiene-modified phenolic resin, a novolac type phenolic resin synthesized from bisphenol A and resorcinol, a polyhydric phenolic compound, an acid anhydride, and an aromatic amine.

The additional compound may include at least one of a phenol aralkyl curing agent having a novolac structure represented by Formula 6:

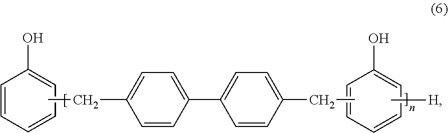

wherein, in Formula 6, n is about 1 to about 7,

a xyloc curing agent represented by Formula 7:

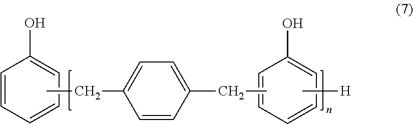

wherein, in Formula 7, n is about 1 to about 7, or

a multifunctional curing agent represented by Formula 8:

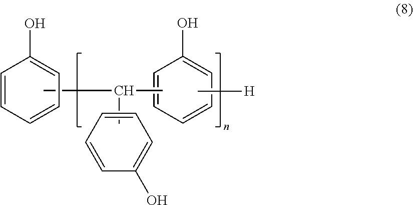

wherein, in Formula 8, n is about 1 to about 7.

The epoxy resin and the curing agent may be included in the composition in an amount such that a ratio of an epoxy equivalent weight of the epoxy resin to a phenolic hydroxyl equivalent weight of the curing agent is about 0.3:1 to about 2.5:1.

The embodiments may also be realized by providing a semiconductor device encapsulated with the epoxy resin composition according to an embodiment.

### DETAILED DESCRIPTION

Example embodiments will now be described more fully hereinafter; however, they may be embodied in different forms and should not be construed as limited to the embodiments set forth herein. Rather, these embodiments are provided so that this disclosure will be thorough and complete, and will fully convey exemplary implementations to those skilled in the art.

It will also be understood that when a layer or element is referred to as being “on” another element, it can be directly on the other element, or intervening elements may also be present.

An embodiment provides an epoxy resin composition. The epoxy resin composition may include, e.g., an epoxy resin, a curing agent, a curing accelerator, and an inorganic filler.

A. Epoxy Resin

The epoxy resin may be a suitable epoxy resin composition for encapsulating semiconductor devices. For example, an epoxy resin having two or more epoxy groups in the molecule may be used without particular limitation. Examples of suitable epoxy resins may include epoxy monomers, epoxy oligomers, and epoxy polymers. The epoxy resins may be used alone or in combination of two or more thereof.

In an implementation, the epoxy resin may include, e.g., epoxy resins obtained by epoxidation of condensation products of phenol or alkyl phenols and hydroxybenzaldehyde, phenol novolac type epoxy resins, cresol novolac type epoxy resins, multifunctional epoxy resins, naphthol novolac type epoxy resins, novolac type epoxy resins of bisphenol A/bisphenol F/bisphenol AD, glycidyl ethers of bisphenol A/bisphenol F/bisphenol AD, bishydroxybiphenyl type epoxy resins, dicyclopentadiene type epoxy resins, biphenyl type epoxy resins, multiaromatic-modified epoxy resins, bisphenol A type epoxy resins, ortho-cresol novolac type epoxy resins, phenol aralkyl type epoxy resins, and naphthalene type epoxy resins. The epoxy resins may be used alone or in combination of two or more thereof.

The epoxy resin may be capable of imparting excellent mechanical properties to the epoxy resin composition and/or an encapsulant prepared from the composition. In an implementation, the epoxy resin may include a phenol aralkyl type epoxy resin having a novolac structure including at least one biphenyl moiety in the molecule, as represented by Formula 2, below.

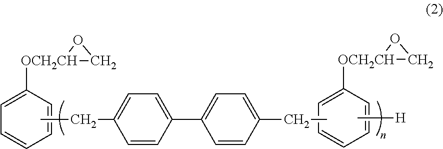

In Formula 2, n may be an average of about 1 to about 7, e.g., n may be about 1 to about 7.

In an implementation, the epoxy resin may include a biphenyl type epoxy resin represented by Formula 3, below.

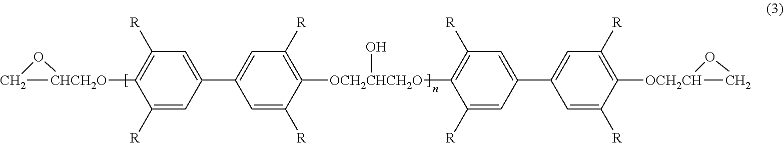

In Formula 3, each R may be a methyl group, and n may be an average of about 0 to about 7, e.g., n may be 0 to about 7.

In an implementation, the epoxy resin may include a xyloc type epoxy resin represented by Formula 4, below.

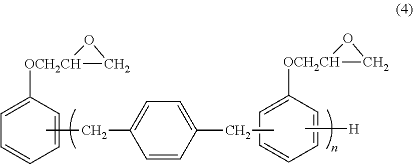

In Formula 4, n may be an average of about 1 to about 7, e.g., n may be about 1 to about 7.

In an implementation, the epoxy resin may include a multifunctional epoxy resin including naphthalene skeletons represented by Formula 5, below.

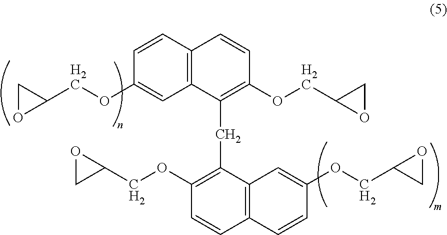

In Formula 5, n and m may each independently be an average of about 0 to about 6, e.g., n may be 0 to about 6 and m may be 0 to about 6. In an implementation, the epoxy resin may include a combination of any of the epoxy resins represented by Formulae 2-5.

The epoxy resin may be included in the composition in an amount of about 1 to about 13% by weight, e.g., about 3 to about 9% by weight, based on a total weight of the composition.

The epoxy resin may also be used in the form of an adduct, e.g., a melt master batch obtained by pre-reacting with the curing agent, the curing accelerator, and other additives, such as a release agent and a coupling agent.

B. Curing Agent

The curing agent may include a compound having a multifunctional novolac structure including at least one biphenyl moiety, as represented by Formula 1, below.

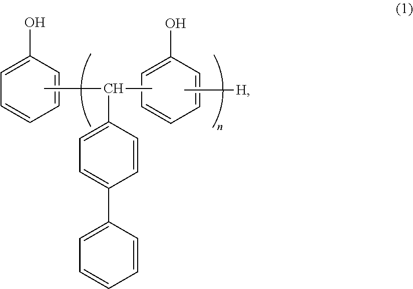

In Formula 1, n may be an average of about 1 to about 10, e.g., n may be about 1 to about 10.

The presence of the curing agent may increase a crosslinking density of the epoxy resin composition, leading to an increase in a glass transition temperature of the epoxy resin composition. Accordingly, the epoxy resin composition may undergo low shrinkage on curing, which indicates good warpage resistance. The presence of the biphenyl moiety in the curing agent may help ensure that the epoxy resin composition exhibits excellent moisture resistance, toughness, and crack resistance. In addition, the presence of the biphenyl moiety may facilitate the formation of char layers upon combustion, despite the relatively high crosslinking density of the epoxy resin composition. Accordingly, the use of the curing agent may help improve the flame retardancy of the epoxy resin composition relative to another epoxy resin composition having a similar glass transition temperature.

The curing agent may have a hydroxyl equivalent weight of about 100 to about 350 g/eq, e.g., about 180 to about 300 g/eq. Within this range, the epoxy resin composition may have a good balance of curing shrinkage, curability, and flowability.

The curing agent may have a softening point of about 50 to about 140° C., e.g., about 60 to about 130° C. The curing agent may have a melt viscosity of about 0.08 to about 3 poise at 150° C., e.g., about 0.1 to about 2.5 poise at 150° C. Within the melt viscosity range defined above, the flowability of the epoxy resin composition during melting, as well as the moldability of the epoxy resin composition may not be deteriorated.

The curing agent may be synthesized by a suitable method. For example, the curing agent may be synthesized by mixing 4-phenylbenzaldehyde with phenol to prepare a solution, and allowing the solution to react at about 80 to about 120° C. in the presence of an organic acid catalyst. However, the synthesis of the curing agent is not limited to this method.

The epoxy resin composition may use the curing agent of Formula 1 in combination with another suitable curing agent for epoxy resin compositions.

The additional curing agent may include a suitable curing agent used for the encapsulation of semiconductor devices and that has two or more phenolic hydroxyl groups. The additional curing agent may include, e.g., a monomer, an oligomers, a polymer, and/or mixtures thereof.

Examples of curing agents that can be used in combination with the curing agent of Formula 1 may include a phenol aralkyl type phenolic resin, a phenol novolac type phenolic resin, a xyloc type phenolic resin, a cresol novolac type phenolic resin, a naphthol type phenolic resin, a terpene type phenolic resin, a multifunctional type phenolic resin, a multiaromatic phenolic resin, a dicyclopentadiene type phenolic resin, a terpene-modified phenolic resin, a dicyclopentadiene-modified phenolic resin, a novolac type phenolic resin synthesized from bisphenol A and resorcinol, a polyhydric phenolic compound (including tris(hydroxyphenyl)methane and dihydroxybiphenyl), an acid anhydride (including maleic anhydride and phthalic anhydride), and an aromatic amine (including metaphenylenediamine, diaminodiphenylmethane, and diaminodiphenylsulfone).

In an implementation, the curing agent that can be used in combination with the curing agent of Formula 1 may include a phenol aralkyl type curing agent having a novolac structure including at least one biphenyl moiety in the molecule, as represented by Formula 6, below.

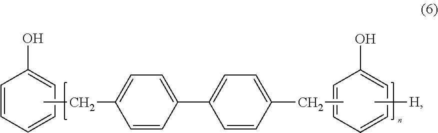

In Formula 6, n may be an average of about 1 to about 7, e.g., n may be about 1 to about 7.

In an implementation, the curing agent that can be used in combination with the curing agent of Formula 1 may include a xyloc type curing agent represented by Formula 7, below.

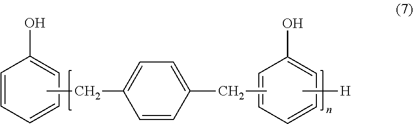

In Formula 7, n may be an average of about 1 to about 7, e.g., n may be about 1 to about 7.

In an implementation, the curing agent that can be used in combination with the curing agent of Formula 1 may include a multifunctional curing agent represented by Formula 8, below.

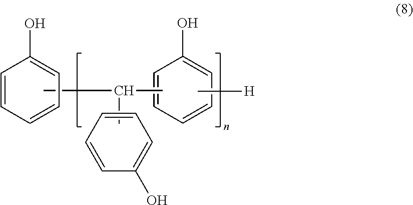

In Formula 8, n may be an average of about 1 to about 7, e.g., n may be about 1 to about 7.

In an implementation, the curing agent that can be used in combination with the curing agent of Formula 1 may include a phenol novolac type curing agent represented by Formula 9, below.

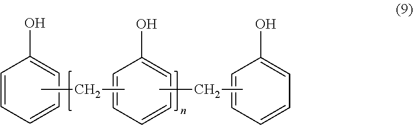

In Formula 9, n may be an average of about 1 to about 7, e.g., n may be about 1 to about 7.

In an implementation, the curing agent that can be used in combination with the curing agent of Formula 1 may include a combination or mixture of any of the curing agents represented by Formulae 6-9.

When the curing agent of Formula 1 and the at least one additional curing agent (selected from those mentioned above) are used in the epoxy resin composition, the curing agent of Formula 1 may be included in the composition in an amount of at least about 30% by weight, e.g., at least about 50% by weight or about 60 to about 100% by weight, based on a total weight of all curing agents. Within this range, low curing shrinkage of the epoxy resin composition can be ensured, and good adhesion strength, reliability, and flowability of the epoxy resin composition may be obtained.

The curing agent may also be used in the form of an adduct, e.g., a melt master batch obtained by pre-reacting with the epoxy resin, the curing accelerator, and other additives.

The epoxy resin and the curing agent may be included in the composition in relative amounts such that a ratio of the epoxy equivalent weight of the epoxy resin to the phenolic hydroxyl equivalent weight of the curing agent is from about 0.3:1 to about 2.5:1, e.g., about 0.6:1 to about 1.5:1. Within this range, high flowability of the epoxy resin composition may be ensured, without extending curing time.

The curing agent may be included in the composition in an amount of about 1 to about 15% by weight, e.g., about 2 to about 12% by weight, based on the weight of the epoxy resin composition. Within this range, the flowability, flame retardancy, adhesion strength, and reliability of the epoxy resin composition may be improved.

C. Curing Accelerator

The curing accelerator may be a substance that helps promote a reaction between the epoxy resin and the curing agent. The curing accelerator may include a suitable curing accelerator, e.g., a tertiary amine, an organometallic compound, an organophosphorus compound, an imidazole compound, and/or a boron compound. Specific examples of suitable tertiary amines may include benzyldimethylamine, triethanolamine, triethylenediamine, dimethylaminoethanol, tri(dimethylaminomethyl)phenol, 2-2-(dimethylaminomethyl)phenol, 2,4,6-tris(diaminomethyl)phenol, and salts of tri-2-ethylhexanoic acid. Specific examples of suitable organometallic compounds may include chromium acetylacetonate, zinc acetylacetonate, and nickel acetylacetonate. Specific examples of suitable organophosphorus compounds may include tris(4-methoxy)phosphine, tetrabutylphosphonium bromide, tetraphenylphosphonium bromide, phenylphosphine, diphenylphosphine, triphenylphosphine, triphenylphosphine triphenylborane, and triphenyl-phosphine-1,4-benzoquinone adducts. Specific examples of suitable imidazole compounds may include 2-methylimidazole, 2-phenylimidazole, 2-aminoimidazole, 2-methyl-1-vinylimidazole, 2-ethyl-4-methylimidazole, and 2-heptadecylimidazole. Specific examples of suitable boron compounds may include tetraphenylphosphonium tetraphenylborate, triphenylphosphine tetraphenylborate, tetraphenylboron salts, trifluoroborane-n-hexylamine, trifluoroborane monoethylamine, tetrafluoroborane triethylamine, and tetrafluoroborane amine. In addition to these curing accelerators, 1,5-diazabicyclo[4.3.0]non-5-ene (DBN), 1,8-diazabicyclo[5.4.0]undec-7-ene (DBU), and phenol novolac resin salts may be used.

The curing accelerator may also be used in the form of an adduct obtained by pre-reacting with the epoxy resin and/or the curing agent.

The curing accelerator may be included in the composition in an amount of about 0.001 to about 1.5% by weight, e.g., about 0.01 to about 1% by weight, based on the total weight of the epoxy resin composition. Within this range, curing time may not be extended and high flowability of the epoxy resin composition may be ensured.

D. Inorganic Filler

The inorganic filler may help improve mechanical properties of the epoxy resin composition and may help reduce stress in the epoxy resin composition. Examples of suitable inorganic fillers may include fused silica, crystalline silica, calcium carbonate, magnesium carbonate, alumina, magnesia, clay, talc, calcium silicate, titanium oxide, antimony oxide, and glass fiber. In an implementation, the inorganic filler may include fused silica having a low coefficient of linear expansion, in consideration of stress reduction.

The fused silica may refer to amorphous silica having a specific gravity not higher than about 2.3. The fused silica may be prepared by, e.g., melting crystalline silica or may include amorphous silica products synthesized from various raw materials.

Before use, the inorganic filler may be surface treated with at least one coupling agent selected from epoxysilanes, aminosilanes, mercaptosilanes, alkylsilanes and alkoxysilanes.

There is no particular restriction as to the shape and particle diameter of the inorganic filler, e.g., the fused silica. For example, the inorganic filler may be spherical fused silica having an average particle diameter of about 0.001 to about 30 μm. In an implementation, the inorganic filler may include a mixture of spherical fused silica products having different particle diameters. The particle diameter of the inorganic filler may also be adjusted to a maximum of, e.g., about 45 μm, about 55 μm, or about 75 μm depending on the application of the epoxy resin composition and the structure of a package to which the epoxy resin composition is to be applied. For example, the inorganic filler may include a mixture of first spherical fused silica having an average particle diameter of about 15 to about 30 μm and second spherical fused silica having an average particle diameter of about 0.01 to about 10 μm in a weight ratio of about 5:1 to about 10:1.

The inorganic filler may be included in a suitable amount, depending on desired physical properties of the epoxy resin composition, e.g., moldability, low-stress properties, and high-temperature strength. In an implementation, the inorganic filler may be included in the composition in an amount of about 70 to about 94% by weight, e.g., about 82 to about 92% by weight, based on the weight of the epoxy resin composition. Within this range, good flame retardancy, flowability, and reliability of the epoxy resin composition may be ensured.

E. Flame Retardant

The epoxy resin composition of the present invention may further include a flame retardant. For example, the flame retardant may include a non-halogenated flame retardant.

The non-halogenated flame retardant may include, e.g., an organic non-halogenated flame retardant, an inorganic non-halogenated flame retardant, or a mixture thereof. Examples of suitable non-halogenated flame retardants may include phosphazene, zinc borate, aluminum hydroxide, and magnesium hydroxide. The flame retardancy of the flame retardant may vary depending on various factors, e.g., the content of the inorganic filler and the kind of the curing agent. Thus, the flame retardant may be included in a suitable amount, depending on the desired flame retardancy of the epoxy resin composition. For example, when the inorganic filler is included in an amount of about 70 to about 82% by weight, the flame retardant may be included in an amount of about 3 to about 10% by weight, based on the weight of the epoxy resin composition. In an implementation, when the inorganic filler is included in an amount of about 82 to about 94% by weight, the flame retardant may be included in an amount of about 0 to about 3% by weight, based on the weight of the epoxy resin composition. The amount of the flame retardant included in the composition may not be determined only by the amount of the inorganic filler, but may also be from about 0 to about 10% by weight, based on the weight of the epoxy resin composition.

In an implementation, the epoxy resin composition may include, e.g., about 1 to about 13% by weight of the epoxy resin, about 1 to about 15% by weight of the curing agent, about 0.001 to about 1.5% by weight of the curing accelerator, about 74 to about 94% by weight of the inorganic filler, and about 0.001 to about 10% by weight of the non-halogenated flame retardant.

F. Additives

The epoxy resin composition may further include one or more additives selected from, e.g., colorants, coupling agents, release agents, stress-relieving agents, crosslinking enhancers, and leveling agents.

Examples of suitable colorants may include carbon black, organic dyes, and inorganic dyes. Examples of suitable coupling agents may include epoxysilanes, aminosilanes, mercaptosilanes, alkylsilanes, and alkoxysilanes. Examples of suitable release agents may include paraffin type waxes, ester type waxes, higher fatty acids, metal salts of higher fatty acids, natural fatty acids, and metal salts of natural fatty acids. Examples of suitable stress-relieving agents may include modified silicone oils, silicone elastomers, silicone powders, and silicone resins. The additives may be included in an amount of about 0.1 to about 5.5% by weight, based on the weight of the epoxy resin composition.

There epoxy resin composition may be prepared by a suitable method. For example, the epoxy resin composition may be prepared by the following procedure. First, all components of the composition may be homogenized using a suitable mixer, such as a Henschel mixer or a Redige mixer. The mixture may be melt-kneaded in a roll mill or a kneader, cooled, and pulverized. Low-pressure transfer molding may be used to encapsulate a semiconductor device with the epoxy resin composition. Injection molding or casting may also be used to mold the epoxy resin composition. Semiconductor devices that can be fabricated by the method may include copper lead frames, iron lead frames, iron lead frames pre-plated with at least one of nickel, copper and palladium, and organic laminate frames.

Another embodiment provides a semiconductor device encapsulated with the epoxy resin composition, e.g., with an encapsulant prepared from the composition. The semiconductor device may be encapsulated with the epoxy resin composition by a suitable method.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### EXAMPLES

Detailed specifications of components used in Examples 1-3 and Comparative Examples 1-6 are as follows:

A. Epoxy Resins

A1: Phenol aralkyl type epoxy resin (NC-3000, Nippon Kayaku)

A2: Multifunctional epoxy resin including naphthalene skeletons (1-IP-4770, DIC)

B. Curing Agents

B1: Phenolic resin having a multifunctional novolac structure (Formula 1, softening point=108° C., hydroxyl equivalent weight=204 g/eq.) synthesized by reaction of phenol and 4-phenylbenzaldehyde

B2: Phenol aralkyl type phenolic resin (MEH-7851SS, Meiwa Kasei)

B3: Multifunctional phenolic resin (MEH-7500-35, Meiwa Kasei)

B4: Phenol novolac type phenolic resin (HF-1M, Meiwa Kasei)

C. Curing Accelerator

Triphenylphosphine (TPP, Hokko). The catalyst was added in an amount of 3 parts per hundred resin (phr) relative to the epoxy resin(s).

D. Inorganic Filler

Mixture of spherical fused silica having an average particle diameter of 18 μm and spherical fused silica having an average particle diameter of 0.5 μm in a weight ratio of 9:1

E. Flame retardant

Magnesium hydroxide (MGZ-6R, Sakai Chemical)

F1. Coupling agents

F11: Mercaptopropyltrimethoxysilane (KBM-803, Shinetsu)

F12: Methyltrimethoxysilane (SZ-6070, Dow Corning Chemical)

F2. Colorant

Carbon black (MA-600, Matsushita Chemical)

F3. Release agent

Carnauba wax

### Examples 1-3

The epoxy resins (A), the curing agents (B), the curing accelerator (C), the inorganic filler (D), the flame retardant (E), the coupling agents (F1), the colorant (F2), and the release agent (F3) were added in accordance with the compositions shown in Table 1, below, homogenized using a Henschel mixer, melt-kneaded using a continuous kneader at 95° C., cooled, and pulverized to prepare epoxy resin compositions for encapsulating semiconductor devices.

### Comparative Examples 1-6

Epoxy resin compositions for encapsulating semiconductor devices were prepared in the same manner as in Examples 1-3, except that the contents of the epoxy resins, the curing agents, the curing accelerator, the inorganic filler, the flame retardant, the coupling agents, the colorant, and the release agent were changed as shown in Table 1.

TABLE 1

| | | Example No. | | | Comparative Example No. | | | | | |
|---|---|---|---|---|---|---|---|---|---|---|
| | | 1 | 2 | 3 | 1 | 2 | 3 | 4 | 5 | 6 |
| A | A1 | 6.67 | — | 3.12 | 6.73 | 8.5 | 8.41 | — | — | — |
| | A2 | — | 5.85 | 3.12 | — | — | — | 5.93 | 7.82 | 7.72 |
| B | B1 | 5.13 | 5.97 | 5.58 | — | — | — | — | — | — |
| | B2 | — | — | — | 5.06 | — | — | 5.9 | — | — |
| | B3 | — | — | — | — | 3.24 | — | — | 3.95 | — |
| | B4 | — | — | — | — | — | 3.33 | — | — | 4.05 |
| C | | 0.2 | 0.18 | 0.19 | 0.21 | 0.6 | 0.26 | 0.17 | 0.23 | 0.23 |
| D | | 86.1 | 86.1 | 86.09 | 86.1 | 86.1 | 86.1 | 86.1 | 86.1 | 86.1 |
| E | | 1 | 1 | 1 | 1 | 1 | 1 | 1 | 1 | 1 |
| F1 | F11 | 0.2 | 0.2 | 0.2 | 0.2 | 0.2 | 0.2 | 0.2 | 0.2 | 0.2 |
| | F12 | 0.2 | 0.2 | 0.2 | 0.2 | 0.2 | 0.2 | 0.2 | 0.2 | 0.2 |

| | | | | | | | | | |
|---|---|---|---|---|---|---|---|---|---|
| F2 | 0.3 | 0.3 | 0.3 | 0.3 | 0.3 | 0.3 | 0.3 | 0.3 | 0.3 |
| F3 | 0.2 | 0.2 | 0.2 | 0.2 | 0.2 | 0.2 | 0.2 | 0.2 | 0.2 |

Experimental Example 1: Evaluation of physical properties of the epoxy resin compositions

The epoxy resin compositions prepared in Examples 1-3 and Comparative Examples 1-6 were evaluated for physical properties shown in Table 2. The results are shown in Table 2, below.

Methods for Evaluation of Physical Properties

1. Curing shrinkage: Each of the epoxy resin compositions was molded using a transfer molding press in an ASTM mold for flexural strength specimen construction at 175° C. and 70 kgf/cm² under the following conditions: transfer pressure=1,000 psi, transfer speed=0.5-1 cm/s and curing time=120 sec. As a result of the molding, a specimen (125×12.6×6.4 mm) was obtained. The specimen was subjected to post-molding cure (PMC) in an oven at 170-180° C. for 4 hr, and cooled. The length of the specimen was measured.

The curing shrinkage of the epoxy resin composition was calculated by the following equation:

Curing Shrinkage=(Length of the mold at 175° C.−Length of the specimen)÷(Length of the mold at 175° C.)×100

2. Glass transition temperature was measured using a thermomechanical analyzer (TMA) while heating at a rate of 10° C./min from 25° C. to 300° C.

3. Moisture absorption: Each of the resin compositions prepared in Examples 1-3 and Comparative Examples 1-6 was molded at a mold temperature of 170-180° C., a pressure of 70 kg/cm², a transfer pressure of 1,000 psi and a transfer speed of 0.5-1 cm/s for a curing time of 120 sec to obtain a cured specimen in the form of a disk having a diameter of 50 mm and a thickness of 1 mm. The specimen was subjected to post-molding cure (PMC) in an oven at 170-180° C. for 4 hr and allowed to stand at 85° C. and 85 RH % for 168 hr. The weights of the specimen before and after moisture absorption were measured. The moisture absorption of the resin composition was calculated by the following equation:

Moisture absorption(%)=(Weight of the specimen after moisture absorption−Weight of the specimen before moisture absorption)÷(Weight of the specimen before moisture absorption)×100

4. Flame retardancy was evaluated using a ⅛ inch thick specimen according to the UL94 V-0 standard.

5. Adhesive strength: A copper metal device having a specification adapted to a mold for adhesive strength measurement was prepared as a test piece. Each of the resin compositions prepared in Examples 1-3 and Comparative Examples 1-6 was molded on the test piece at a mold temperature of 170-180° C., a pressure of 70 kgf/cm², a transfer pressure of 1,000 psi and a transfer speed of 0.5-1 cm/s for a curing time of 120 sec to obtain a cured specimen. The specimen was subjected to post-molding cure (PMC) in an oven at 170-180° C. for 4 hr. The area of the epoxy resin composition in contact with the specimen was 40±1 mm². The adhesive strength of the epoxy resin composition was measured using a universal testing machine (UTM). 12 specimens were produced for each composition. After the measurement procedure was repeated, the measured adhesive strength values were averaged.

6. Warpage resistance: Each of the compositions prepared in Examples 1-3 and Comparative Examples 1-6 was transfer molded on a copper metal device using a multi plunger system (MPS) at 175° C. for 70 sec to construct an exposed thin quad flat package (eTQFP) having a width of 20 mm, a length of 20 mm and a thickness of 1 mm. The package was subjected to post molding cure at 175° C. for 4 hr and cooled to 25° C. Thereafter, a height difference between the diagonal center of the upper surface of the package and the highest corner of the package was measured. A smaller height difference indicates better warpage resistance.

7. Reliability: The eTQFP package for warpage resistance evaluation was dried at 125° C. for 24 hr. After 5 cycles of thermal shock testing (1 cycle refers to a series of exposures of the package to −65° C. for 10 min, 25° C. for 10 min, and 150° C. for 10 min), the package was allowed to stand at 85° C. and 60% RH for 168 hr and passed through IR reflow three times at 260° C. for 30 sec (preconditioning). After preconditioning, the occurrence of external cracks in the package was observed using an optical microscope, and the occurrence of peeling between the epoxy resin composition and the lead frame was evaluated by scanning acoustic microscopy (C-SAM) as a non-destructive testing method. External cracks of the package or peeling between the epoxy resin composition and the lead frame cannot guarantee reliability of the package.

TABLE 2

| | | | Example No. | | | Comparative Example No. | | | | | |
|---|---|---|---|---|---|---|---|---|---|---|---|
| | | | 1 | 2 | 3 | 1 | 2 | 3 | 4 | 5 | 6 |
| Basic physical | Curing shrinkage (%) | | 0.21 | 0.13 | 0.18 | 0.27 | 0.24 | 0.24 | 0.23 | 0.18 | 0.18 |
| properties | Glass transition temp. (° C.) | | 164 | 174 | 170 | 135 | 160 | 161 | 153 | 172 | 174 |
| | Moisture absorption (wt %) | | 0.18 | 0.20 | 0.20 | 0.21 | 0.26 | 0.27 | 0.22 | 0.27 | 0.27 |
| | Flame retardancy | | V-0 | V-0 | V-0 | V-0 | V-1 | V-1 | V-0 | V-1 | V-1 |
| | Adhesive strength (kg_{f}) | | 70 | 60 | 65 | 68 | 58 | 57 | 58 | 52 | 48 |
| Evaluation of | Warpage (mil) | | 1.45 | 0.82 | 1.22 | 2.40 | 1.72 | 1.84 | 1.67 | 1.24 | 1.23 |
| packages | Reliability | Number of external | 0 | 0 | 0 | 0 | 0 | 0 | 0 | 0 | 0 |
| | | cracks | | | | | | | | | |
| | | Number of peelings | 0 | 0 | 0 | 0 | 22 | 22 | 3 | 22 | 22 |
| | | Total number of | 22 | 22 | 22 | 22 | 22 | 22 | 22 | 22 | 22 |
| | | semiconductors | | | | | | | | | |
| | | tested | | | | | | | | | |

The composition of Comparative Example 1 (using the phenol aralkyl type epoxy resin and the phenol aralkyl type phenolic resin) had a low moisture absorption and showed excellent adhesion properties. The results of evaluation for the package indicate that high reliability could be ensured. However, the composition showed poor warpage resistance of the package due to its low glass transition temperature and high curing shrinkage. The compositions of Comparative Examples 2-3 (each using the phenol aralkyl type epoxy resin and the multifunctional phenolic resin or the phenol novolac type phenolic resin), showed improved warpage resistance due to their higher glass transition temperatures and lower curing shrinkages than the composition of Comparative Example 1 (using the phenol aralkyl type phenolic resin). However, high reliability of the packages could not be ensured due to the high moisture absorptions, and good flame retardancy could not be ensured by the use of the flame retardant in a small amount.

The compositions of Comparative Examples 4-6 (each using the multifunctional epoxy resin including naphthalene skeletons), showed good warpage resistance due to their higher glass transition temperatures and lower curing shrinkages than the compositions of Comparative Examples 1-3 (each using the phenol aralkyl type epoxy resin). However, high reliability of the packages could not be ensured due to the high moisture absorptions and low adhesive strengths.

The composition of Example 1 (using the curing agent having a multifunctional novolac structure including at least one biphenyl moiety) had a glass transition temperature similar to or higher than those of the compositions of Comparative Examples 1-3 (using different curing agents) and had a lower curing shrinkage than the compositions of Comparative Examples 1-3. These results indicate better warpage resistance of the package. In addition, the composition of Example 1 showed good peeling resistance due to its low moisture absorption and high adhesive strength, ensuring high package reliability. Furthermore, the composition of Example 1 could ensure good flame retardancy despite the low content of the flame retardant.

The composition of Example 2 had a glass transition temperature similar to or higher than those of the compositions of Comparative Examples 4-6 (using different curing agents) and had a lower curing shrinkage than the compositions of Comparative Examples 4-6. These results indicate better warpage resistance of the package. In addition, the composition of Example 2 could ensure high package reliability due to its low moisture absorption and high adhesive strength.

By way of summation and review, with the recent distribution of small-sized and thin portable digital devices, semiconductor packages mounted in the digital devices have become increasingly lightweight and small, to increase packaging density per unit volume. In the lightweight and small packages, differences in coefficients of thermal expansion of semiconductor chips, lead frames, and epoxy resin compositions constituting the packages, and thermal shrinkage and curing shrinkage of the epoxy resin compositions encapsulating the packages may cause the packages to warp. Such warpage of the packages may cause defects during soldering in semiconductor post-processes, leading to the occurrence of electrical defects. Thus, warpage resistant epoxy resin compositions for encapsulating semiconductor devices may be desirable.

Improving the warpage resistance of epoxy resin compositions may be associated with increased glass transition temperatures and decreased curing shrinkage of the epoxy resin compositions.

A semiconductor package may be exposed to high temperatures (e.g., about 260° C.) in the course of mounting on a substrate. This exposure may cause moisture present in the package to rapidly expand, leading to internal peeling and external cracking of the package. Reducing the moisture absorption of an epoxy resin composition for encapsulating a semiconductor device in order to protect the package from peeling and cracks may be desirable to achieve high reliability of the package. When the glass transition temperature of the epoxy resin composition is increased to achieve improved warpage resistance, an inevitable increase in the moisture absorption of the composition may result in poor reliability of the package. Accordingly, increasing the glass transition temperature of the package with poor reliability for the purpose of achieving improved warpage resistance may be limited.

Reducing the curing shrinkage of an epoxy resin composition may include increasing an amount of an inorganic filler in the epoxy resin composition. However, this approach may result in low flowability of the epoxy resin composition. Accordingly, increasing the content of the inorganic filler may also be essentially limited.

Accordingly, the embodiments provide an epoxy resin compositions for encapsulating semiconductor devices that have high reliability and good flowability while possessing excellent warpage resistance and that can ensure good flame retardancy even without the use of halogenated flame retardants.

The embodiments provide an epoxy resin composition for encapsulating a semiconductor device that includes a curing agent having a particular structure.

The embodiments provide an epoxy resin composition that has improved warpage resistance, good adhesion to other constituent materials of a semiconductor package, high reliability, and good flame retardancy without the need to include a halogenated flame retardant.

The epoxy resin composition according to an embodiment may have improved warpage resistance due to its high glass transition temperature and low curing shrinkage. In addition, the epoxy resin composition may be highly reliable due to its good adhesiveness and low moisture absorption. Furthermore, the epoxy resin composition may ensure good flame retardancy without the need to use a halogenated flame retardant and thus may be environmentally friendly.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope of the present invention as set forth in the following claims.

What is claimed is:

1. An epoxy resin composition for encapsulating a semiconductor device, the composition comprising:
an epoxy resin;
an inorganic filler;
a curing accelerator; and
a curing agent, the curing agent including a compound having a multifunctional novolac structure including at least one biphenyl moiety, the compound being represented by Formula 1: 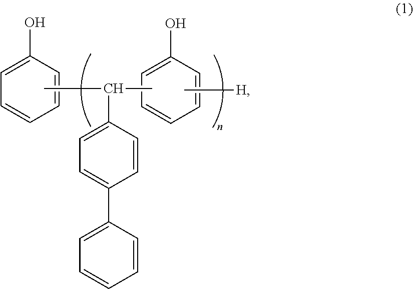
wherein n is about 1 to about 10.

2. The epoxy resin composition as claimed in claim 1, further comprising a non-halogenated flame retardant.

3. The epoxy resin composition as claimed in claim 2, wherein the epoxy resin composition includes:
about 1 to about 13% by weight of the epoxy resin,
about 74 to about 94% by weight of the inorganic filler,
about 0.001 to about 1.5% by weight of the curing accelerator,
about 0.001 to about 10% by weight of the non-halogenated flame retardant, and
about 1 to about 15% by weight of the curing agent.

4. The epoxy resin composition as claimed in claim 2, wherein the non-halogenated flame retardant includes at least one of phosphazene, zinc borate, aluminum hydroxide, and magnesium hydroxide.

5. The epoxy resin composition as claimed in claim 1, wherein the curing agent has a hydroxyl equivalent weight of about 100 g/eq to about 350 g/eq.

6. The epoxy resin composition as claimed in claim 1, wherein the curing agent has a melt viscosity of about 0.08 poise to about 3 poise at 150° C.

7. The epoxy resin composition as claimed in claim 1, wherein the curing agent has a softening point of about 50 to about 140° C.

8. The epoxy resin composition as claimed in claim 1, wherein the compound represented by Formula 1 is present in the composition an amount of about 1 to about 15% by weight, based on a total weight of the epoxy resin composition.

9. The epoxy resin composition as claimed in claim 1, wherein the curing agent further includes at least one additional compound, the additional compound including two or more phenolic hydroxyl groups.

10. The epoxy resin composition as claimed in claim 9, wherein the compound represented by Formula 1 is present in the composition in an amount of about 30% by weight or greater, based on a total weight of the curing agent.

11. The epoxy resin composition as claimed in claim 9, wherein the additional compound includes at least one of a phenol aralkyl type phenolic resin, a phenol novolac type phenolic resin, a xyloc type phenolic resin, a cresol novolac type phenolic resin, a naphthol type phenolic resin, a terpene type phenolic resin, a multifunctional type phenolic resin, a multiaromatic phenolic resin, a dicyclopentadiene type phenolic resin, a terpene-modified phenolic resin, a dicyclopentadiene-modified phenolic resin, a novolac type phenolic resin synthesized from bisphenol A and resorcinol, a polyhydric phenolic compound, an acid anhydride, and an aromatic amine.

12. The epoxy resin composition as claimed in claim 9, wherein the additional compound includes at least one of:
a phenol aralkyl curing agent having a novolac structure represented by Formula 6: 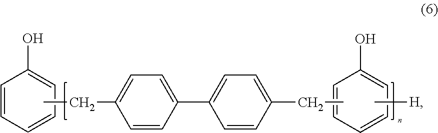
wherein, in Formula 6, n is about 1 to about 7,
a xyloc curing agent represented by Formula 7: 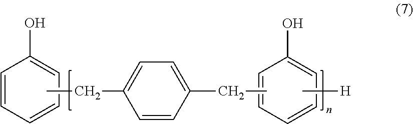
wherein, in Formula 7, n is about 1 to about 7, or
a multifunctional curing agent represented by Formula 8: 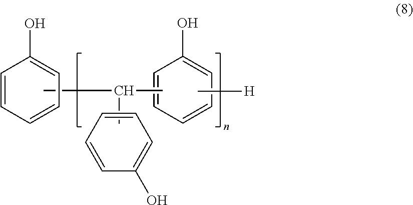
wherein, in Formula 8, n is about 1 to about 7.

13. The epoxy resin composition as claimed in claim 1, wherein the epoxy resin and the curing agent are included in the composition in an amount such that a ratio of an epoxy equivalent weight of the epoxy resin to a phenolic hydroxyl equivalent weight of the curing agent is about 0.3:1 to about 2.5:1.

14. A semiconductor device encapsulated with the epoxy resin composition as claimed in claim 1.
